(19) United States
(12) Patent Application Publication
(10) Pub. No.: US 2007/0201822 A1
(43) Pub. Date: Aug. 30, 2007

(54) Recommended Program Extracting Apparatus And Recommended Program Extracting Method

(76) Inventors: Yoshiaki Kusunoki, Tokyo (JP); Keiji Hatanaka, Tokyo (JP)

Correspondence Address: BIRCH STEWART KOLASCH & BIRCH, PO BOX 747, FALLS CHURCH, VA, 22040-0747, US

(21) Appl. No.: 11/547,750

(22) PCT Filed: Oct. 19, 2005
(86) PCT No.: PCT/JP05/19168

§ 371 Date: Oct. 6, 2006

(30) Foreign Application Priority Data
Feb. 7, 2005 (JP) 2005-029941

(51) Int. Cl. H04N 5/91

(52) U.S. Cl. 386/83

(57) ABSTRACT

A recommended program extracting apparatus that finds a number of a program(s) for each component (such as DRAMA or VARIETY) of the genre, the program(s) being included in the record history information (S103 and S104), determines a number of an assigned program(s) regarding a recommended program(s) for each component of the genre in accordance with the number of the program(s) for each component of the genre (S108), and extracts the recommended program(s) from programs included in the scheduled broadcast program information in such a way that the number of the recommended program(s) is within a range of the number of the assigned program(s) for each component of the genre (S109 to S114).

### TECHNICAL FIELD

The present invention relates to a recommended program extracting apparatus and a recommended program extracting method for extracting a recommended program (e.g., a recommended program to be recorded, a recommended program to be watched, and the like) from among broadcast programs scheduled to be broadcast by the use of program information regarding a broadcast program.

### BACKGROUND ART

There is a broadcast program recording method that includes the steps of reading out program information from among the record history of the programs recorded in the past, retrieving a program having the same information as the read-out program information from among the scheduled broadcast program information, and reserving a program in accordance with a result of the retrieving to record the reserved program (refer to patent document 1, for example). Further, there is another broadcast program recording method that includes the steps of grasping user's preference from the user's operation history, retrieving a program matching the user's preference, and reserving a program in accordance with a result of the retrieving to record the reserved program (refer to patent document 2, for example). Furthermore, there is still another broadcast program recording method that includes the steps of previously specifying conditions of a program, the recording reservation of which is desired by the user, regularly retrieving the scheduled broadcast program information, and automatically recording a program matching the conditions (refer to patent document 3, for example).

Patent document 1: Japanese Patent Application Kokai (Laid Open) Publication No. 2001-257974 (paragraphs 0029-0031, FIG. 1)

Patent document 2: Japanese Patent Application Kokai (Laid Open) Publication No. 2001-86420 (paragraphs 0056-0057, FIG. 1 and FIG. 12)

Patent document 3: Japanese Patent Application Kokai (Laid Open) Publication No. H7-121935 (paragraphs 0014-0016, FIG. 1)

### DISCLOSURE OF THE INVENTION

### Problems to be Solved by the Invention

However, in the above-mentioned conventional methods, the programs to be recorded are recommended in accordance with a recording/reproducing history in the past, an operation history in the past, or contents inputted by a user through reservation means. Therefore, the conventional methods have a problem that there is a tendency that programs meeting the user's preference and interest are hardly to be recommended. In particular, the conventional methods have a problem that there is a tendency that even in a case where the user has recorded programs of a variety of genres, the recommended programs are selected mainly from specific genre and therefore are hardly to be selected from respective genres reflecting a plurality of preferences and interests of the user.

Therefore, the present invention has been made to solve the above-mentioned problems of the conventional technology. The object of the present invention is to provide a recommended program extracting apparatus and a recommended program extracting method capable of extracting a recommended program for each component of predetermined evaluation items on an equitable basis.

### Means for Solving the Problems

A recommended program extracting apparatus according to the present invention includes a recording section which records an inputted broadcast signal in a predetermined recording medium; a program information acquiring section which acquires program information regarding a broadcast program from the broadcast signal; a record history storing section which stores record history information which is program information regarding a past broadcast program recorded by the recording section; and a recommended program extracting section which performs a statistical process of the record history information, the recommended program extracting section extracting a recommended program from programs included in scheduled broadcast program information acquired by the program information acquiring section in accordance with a result of the statistical process. The recommended program extracting section finds a number of a program for each component of a predetermined first evaluation item, the program being included in the record history information, determines a number of an assigned program regarding the recommended program for each component of the first evaluation item in accordance with the number of the program for each component of the first evaluation item, and extracts the recommended program in such a way that the number of the recommended program is within a range of the number of the assigned program for each component of the first evaluation item.

### Effect of the Invention

The apparatus according to the present invention finds a number of a program for each component of a predetermined first evaluation item, the program being included in the record history information, determines a number of an assigned program regarding the recommended program for each component of the first evaluation item in accordance with the number of the program for each component of the first evaluation item, and extracts the recommended program in such a way that the number of the recommended program is within a range of the number of the assigned program for each component of the first evaluation item. Therefore, the invention has an effect that a plurality of programs reflecting a plurality of preferences and interests of the user can be recommended.

### BRIEF DESCRIPTION OF THE DRAWINGS

FIG. 1 is a block diagram schematically showing a configuration of a recommended program extracting apparatus according to the first embodiment of the present invention;

FIG. 2 is a block diagram schematically showing a software configuration of the recommended program extracting apparatus according to the first embodiment;

FIG. 3 is a flow chart showing the operation of the recommended program extracting apparatus according to the first embodiment;

FIG. 4 is a diagram showing the record history information in the recommended program extracting apparatus according to the first embodiment;

FIG. 5 is a diagram showing a ranking determination result of a genre and a broadcast start time zone in the recommended program extracting apparatus according to the first embodiment;

FIG. 6 is a diagram showing a point table in which points are related to the rankings of components of the genre and the broadcast start time zone in the recommended program extracting apparatus according to the first embodiment;

FIG. 7 is a diagram showing a mapping point table in which points are related to the components of the genre and the broadcast start time zone in the recommended program extracting apparatus according to the first embodiment;

FIG. 8 is a diagram showing the number of the assigned programs for each genre determined in the recommended program extracting apparatus according to the first embodiment;

FIG. 9 is a diagram showing recommended program extraction results in the first and second embodiments and in a comparative example;

FIG. 10 is a flow chart showing the operation of a recommended program extracting apparatus according to the second embodiment; and

FIG. 11 is a diagram showing the number of the assigned programs for each genre determined in the recommended program extracting apparatus according to the second embodiment.

### DESCRIPTION OF THE REFERENCE SYMBOLS

1 recommended program extracting apparatus; 2 antenna; 3 remote controller; 4 monitor; 5 TV tuner; 6 A/D converter; 7 MPEG encoder; 8 recording buffer; 9 slicer; 10 CPU; 11 HDD controller; 12 HDD; 13 volatile memory; 14 MPEG decoder; 15 reading buffer; 16 remote controller I/F; 17 D/A converter; 18 OSD; 19 nonvolatile memory; 20 EPG section; 21 encoder/decoder controller; 22 system controller; 23 display system controller; 24 EPG controller; 25 EPG data analyzer; 26 EPG data backup section; 27 EPG database; 28 recording reservation section; 29 program recommender; E0 recommended program in a case where genre assignment restriction is not applied (comparative example); E1 recommended program in a case where genre assignment restriction is applied in the first embodiment; E2 recommended program in a case where genre assignment restriction using the d'Hondt formula is applied in the second embodiment.

### BEST MODE FOR CARRYING OUT THE INVENTION

### First Embodiment

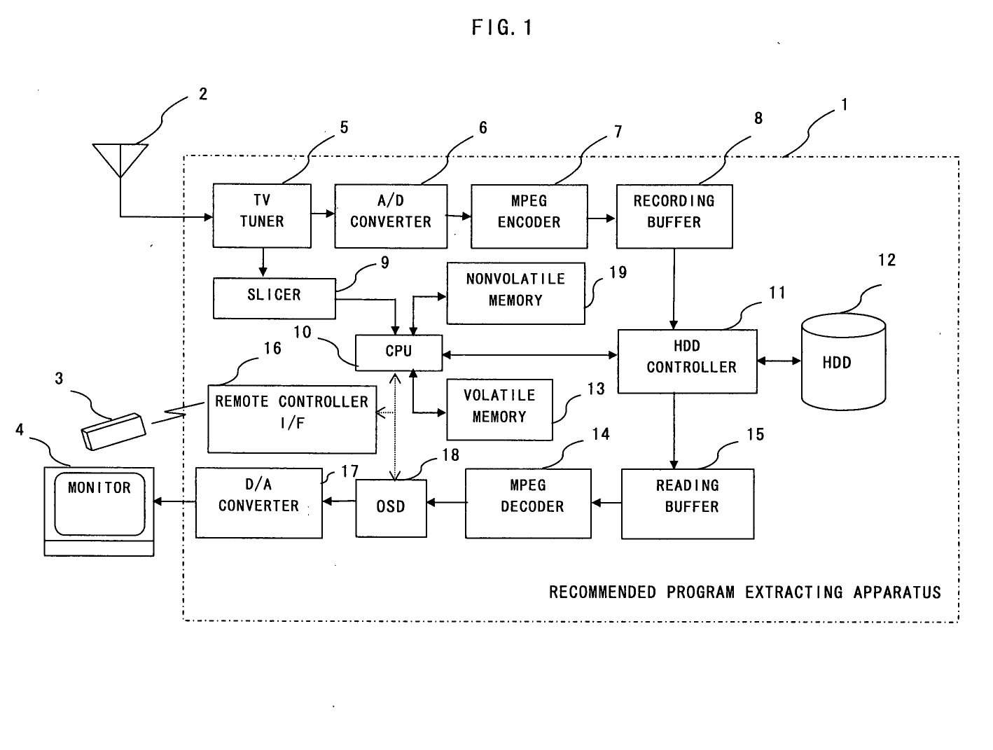

FIG. 1 is a block diagram schematically showing a configuration of a recommended program extracting apparatus 1 according to the first embodiment (or an apparatus capable of performing a recommended program extracting method according to the first embodiment) of the present invention. As shown in FIG. 1, the recommended program extracting apparatus 1 includes a TV (television) tuner 5 connected to an external antenna 2; an A/D (analog to digital) converter 5; an MPEG (Moving Picture Experts Group) encoder 7; a recording buffer 8; a slicer 9 which extracts electronic program group information (EPG information); a CPU 10; an HDD (hard disk drive) controller 11; an HDD 12; a remote controller I/F (interface) 16 for receiving a signal from a remote controller 3; and a nonvolatile memory 19. Further, the recommended program extracting apparatus 1 includes a reading buffer 15; an MPEG decoder 14; an OSD (On-Screen Display) 18; a D/A (digital to analog) converter 17 for outputting an analog image signal to a monitor 4; and a volatile memory 13. As shown in FIG. 1, a case where the recommended program extracting apparatus 1 is a hard disk recording/reproducing apparatus is described in the first embodiment, but the recommended program extracting apparatus 1 may be a recording apparatus using other information recording medium such as a DVD or another apparatus such as a personal computer. Furthermore, when the recommended program extracting apparatus 1 is a personal computer, the personal computer is caused to be able to perform the recommended program extracting method by installing software in the personal computer using an information recoding medium containing a software program for causing the personal computer to be able to perform the recommended program extracting method or using downloading through a communication circuit

Referring to FIG. 1, the TV tuner 5 receives a broadcast program (broadcast signal) via the antenna 2. The TV tuner 5 has a function of tuning to a specified channel and outputs an image and voice signals of the tuned channel to the A/D converter 6. The A/D converter 6 converts the analog image and voice signals outputted from the TV tuner 5 to a digital signal. The MPEG encoder 7 performs MPEG compression of the digital image signal obtained by the digital conversion and outputs a bit stream of the compressed data. The HDD 12 stores the bit stream outputted by the MPEG encoder 7. The HDD controller 11 is a controller for controlling the HDD 12 and controls the writing and reading of the bit stream. The recording buffer 8 is provided for the purpose of recording the bit stream outputted by the MPEG encoder 7 without a dropout when the bit stream is written in the HDD 12.

The MPEG decoder 14 decodes the MPEG compressed bit stream to convert the bit stream to a decompressed digital image signal. The reading buffer 15 previously reads and stores a bit stream required by the MPEG decoder 14 to prevent data underflow during the decoding process. The OSD 18 is a drawing device for superimposing character and image data on the MPEG decoded digital image signal. The D/A converter 17 converts the digital image signal to an analog image signal that the monitor 4 can display.

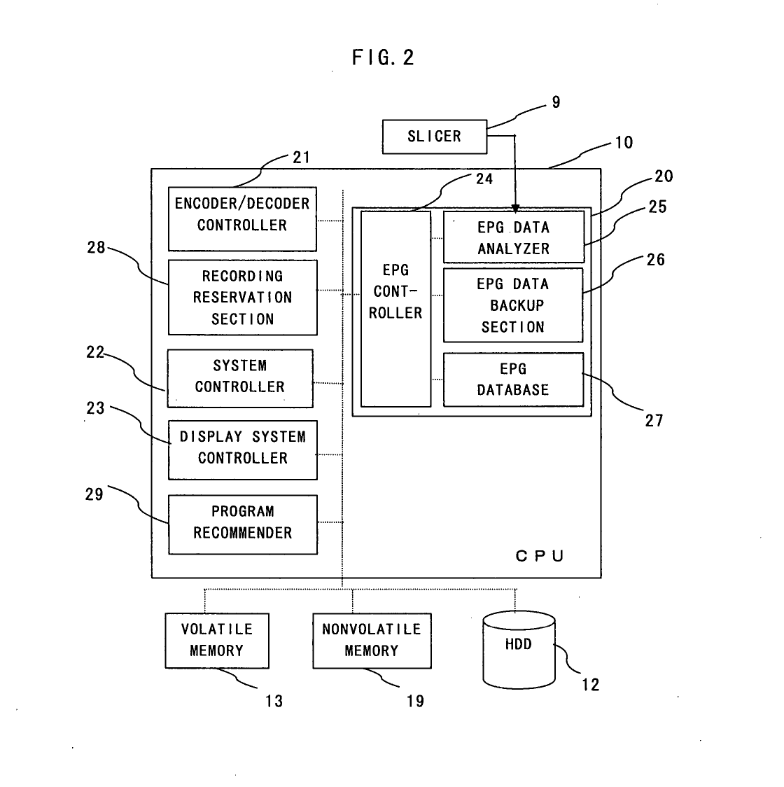

The slicer 9 extracts an EPG superimposed on the VBI (Vertical Blanking Interval) of a broadcast wave. The remote controller I/F 16 receives a control signal from the remote controller 3 and transmits the control signal to the CPU 10. The CPU 10 controls the recommended program extracting apparatus 1 of the first embodiment, and also performs the conversion process of various data and other process. Moreover, to the CPU 10 are connected the volatile memory 13 capable of recording information in a state where it is supplied with power and the nonvolatile memory 19 which can record information even in a state where it is not supplied with power and from which recorded information can be read at the next startup. The nonvolatile memory 19 records the received EPG data, the recommended program extracted by a program recommender 29 (shown in FIG. 2 to be described later), and information such as broadcast start times and genres of programs recorded in the past as a record history.

FIG. 2 is a block diagram conceptually showing a configuration of software that operates in the CPU. 10 of the recommended program extracting apparatus 1 according to the first-embodiment. As shown in FIG. 2, the configuration of the software performed by the CPU 10 includes an EPG section 20, an encoder/decoder controller 21, a system controller 22, a recording reservation section 28, a display system controller 23, and a program recommender 29. The EPG section 20 includes an EPG controller 24, an EPG data analyzer 25, an EPG data backup section 26, and an EPG database 27.

The encoder/decoder controller 21 controls the MPEG encoder 7 and the MPEG decoder 14. The system controller 22 controls the state of the recommended program extracting apparatus 1 in accordance with an input from an operation button (not shown in the figure) provided on the main body, an input from the remote controller I/F 16, and the state of the recorded program extracting apparatus 1. The display system controller 23 causes a display section (not shown in the figure) provided in the main body and an external monitor 4 via the OSD 18 to display the state and the like in accordance with the state of the recommended program extracting apparatus 1. The recording reservation section 28 performs the image recording reservation process set by the user, checks whether or not newly reserved information overlaps already reserved information, and records the contents of reservation in the nonvolatile memory 19.

Moreover, the record history information (for example, a broadcast start time, a genre, and the like) which is program information regarding a broadcast program recorded in the past is also recorded in the nonvolatile memory 19. The EPG controller 24 controls the EPG data analyzer 25, the EPG data buffer section 26, and the EPG database 27 in accordance with the state of the EPG, thereby acquiring the EPG, displaying the EPG data, and performing other process.

The EPG data analyzer 25 analyzes the EPG data extracted by the slicer 9. The program recommender 29 performs a statistical process of programs recorded in the past and determines a recommended program from the EPG data including information regarding the scheduled broadcast program using a result of the statistical process. The detailed operation of the program recommender 29 will be described later.

The EPG data analyzer 25 performs a packet analysis process of dividing the EPG data, which will be transmitted as a packet data in the VBI, into packets and classifying the packets in accordance with kinds of the packets; a decipher process of deciphering the EPG data that is transmitted as ciphered data; and a decompression process of decompressing the EPG data compressed so as to reduce the amount of the transmission data. The EPG data backup section 26 writes the data analyzed by the EPG data analyzer 25 in the volatile memory 13, and makes a backup copy of the EPG data in the nonvolatile memory 19 so as to display a program guide without acquiring the EPG data again when the power of the recommended program extracting apparatus 1 is turned off and is again turned on. The EPG database 27 arranges various kinds of information (for example, a start time, an end time, a length of broadcast time, a channel, a title, and detailed information of a program, and a genre to which the program belongs) included in the EPG data analyzed by the EPG data analyzer 25. Furthermore, the EPG database 27 provides various kinds of APIs (Application Programming Interfaces) for referring to and using the EPG data to the recording reservation section 28, the system controller 22, and the display system controller 23, which are host modules using the EPG data.

Next, the operation of the recommended program extracting apparatus 1 will be described. First, a case where a program is recorded by the recommended program extracting apparatus 1 will be described. It is assumed that the reservation information regarding a program to be recorded has already been set and is stored in the nonvolatile memory 19. Usually, when the recording start time of a reserved program approaches (for example, it gets to three minutes before the recording start time) in the recommended program extracting apparatus 1 in a standby state, the system controller 22 that is previously set up to start by a timer starts up, sends an instruction for start-up to various kinds of modules (all modules such as the encoder/decoder controller 21, the recording reservation section 28, and the display system controller 23) and various kinds of components (all elements in the recommended program extracting apparatus 1 such as the MPEG encoder 7, the MPEG decoder 14, and the HDD 12), and instructs the encoder/decoder controller 21 to bring the MPEG encoder 7 into a recording standby state. When it gets to the recording start time, the TV tuner 5 is tuned to the channel of the reserved program of the broadcast wave received by the antenna 2, and then an image and voice signal is extracted. Further, the A/D converter 6 converts an analog image signal to a digital image signal complying with, for example, the standard Rec 656 or the like. The MPEG encoder 7 performs MPEG compression of the digital image signal. A bit stream outputted from the MPEG encoder 7 is once stored in the recording buffer 8, and then is written in the HDD 12 controlled by the HDD controller 11 in the order of the storage.

Next, the reproducing operation of the recommended program extracting apparatus 1 will be described. A user operates the remote controller 3 (or an operation section of the main body, which is not shown in the figure) to display a list of programs recorded in the HDD 12, for example, on the monitor 4. The user selects a program that the user desires to reproduce from the displayed list of programs, and sends an instruction of reproduction. These processes may include, for example, a process in which the remote controller I/F 16 receives an infrared ray or a radio wave signal sent from the remote controller 3 and sends the contents of the instruction to the CPU 10. The CPU 10 reads a program, which is required to be reproduced, from the HDD 12 via the HDD controller 11, and stores a bit stream in the reading buffer 15. The MPEG decoder 14 reads the bit stream stored in the reading buffer 15, and performs MPEG decoding of the bit stream. The decoded digital image signal is synthesized with other character display signal or the like by the OSD 18, is further converted to an analog image signal by the D/A converter 17, and is outputted to the external monitor 4, whereby an image is displayed on the monitor 4.

Next, a method for acquiring the EPG information by the recommended program extracting apparatus 1 will be described. Here, a case where the EPG data is superimposed on the VBI of a specific channel of a broadcast wave and is transmitted will be described. In the recommended program extracting apparatus 1 having only one TV tuner 5 mounted thereon, when a program being broadcast is being recorded and watched, the TV tuner 5 is being occupied and hence the recommended program extracting apparatus 1 may not receive a channel having EPG data superimposed thereon. For this reason, the recommended program extracting apparatus 1 receives the EPG information when the recommended program extracting apparatus 1 is not apparently supplied with power, for example, is in a standby state. In a case where another TV tuner 5 is provided specifically for receiving the EPG data or in a case of using a method of switching a plurality of TV tuners 5 as appropriate, even when the recommended program extracting apparatus 1 has power supplied thereto or operates, the recommended program extracting apparatus 1 can receive the EPG data.

The recommended program extracting apparatus 1 of the first embodiment includes only one TV tuner 5 mounted thereon, and hence receives the EPG data in the standby state. Now, it is assumed that the recommended program extracting apparatus 1 is in the standby state and that it gets to the time when the EPG data is broadcast. A broadcast wave on which the EPG data is superimposed is received by the antenna 2, the TV tuner 5 is tuned to a channel on which the EPG data is superimposed, and the slicer 9 performs the process of extracting the EPG data superimposed on the VBI of the image signal. The EPG data in the first embodiment is divided into small packets to be transmitted. Each packet has a packet ID indicating the kind of information contained in the packet. Further, the information contained in the packet may be ciphered in case of necessity to prevent the contents of the information from being browsed or tampered with ease. Furthermore, each packet is also subjected to compression process so as to reduce the data size. The EPG data analyzer 20 performs, at appropriate times, the packet analysis of classifying data in the packets of the EPG data subjected to the above-mentioned process in accordance with the kinds of packets; a decipher process of deciphering the ciphered EPG data; and a decompression process of decompressing the compressed EPG data to return the compressed EPG data to the original EPG data. The EPG data is subjected to the above-mentioned process by the EPG analyzer 20 and the processed EPG data is recorded in the volatile memory 13.

The EPG data recorded in the volatile memory 13 is erased when the power of the recommended program extracting apparatus 1 is turned off. Therefore, when the power is turned on the next time, the EPG data which was recorded in the volatile memory 13 cannot be used. For this reason, the EPG data recorded in the volatile memory 13 is recorded for the sake of backup, for example, in the HDD 12 or the nonvolatile memory 19. The backup process is performed after the EPG data is acquired and data analysis is finished. Further, the backup EPG data is subjected to the restoring process of rewriting the EPG data in the volatile memory 13 when the power is turned on the next time. It is the EPG data backup section 26 that performs the backup process and the restoring process of the EPG data. When the EPG data backup section 26 makes a backup copy of the EPG data in the HDD 12 or the nonvolatile memory 19, the EPG data backup section 26 performs the compression process of reducing the data size of EPG data and the cipher process of enhancing the confidentiality of the data. Moreover, the EPG data backup section 26 performs the decompression process of decompressing the compressed EPG data and the decipher process of deciphering the ciphered EPG data, as the restoring process of returning the EPG data from the HDD 12 or the nonvolatile memory 19 to the volatile memory 13. The EPG data recorded in the volatile memory 13 is expanded in a more accessible data format by the EPG database 27. Furthermore, the EPG database 27 supplies the contents of the expanded EPG data using the API to the recording reservation section 28, the system controller 22, the display system controller 23, and the program recommender 29, which are host modules. The API includes a configuration API of the database, and the EPG database 27 expands the EPG data in the volatile memory 13 by calling the configuration API.

Next, the record history information used by the recommended program extracting apparatus 1 will be described. The recommended program extracting apparatus 1 uses a past record history as data indicating user's preference in order to recommend a program. The record history information includes information such as a title, a channel, and a recording (broadcast) start time of the program recorded in the past, and information such as a broadcast start time, an end time, a genre, a performer, and an encode parameter of a program that is now being recorded. When the recording of a program is started, the record history information is recorded in the nonvolatile memory 19. The number of the programs included in the record history information is limited for the convenience of data process performed by the apparatus. It is assumed that, for example, the record history information has a predetermined number of the programs (for example, one thousand programs) in order counted from the most recent content first. The recorded program information of programs over the predetermined number of the programs is deleted in order from the oldest program. Moreover, the number of the programs of the record history information may be restricted in accordance with other conditions such as record day and time (for example, one year).

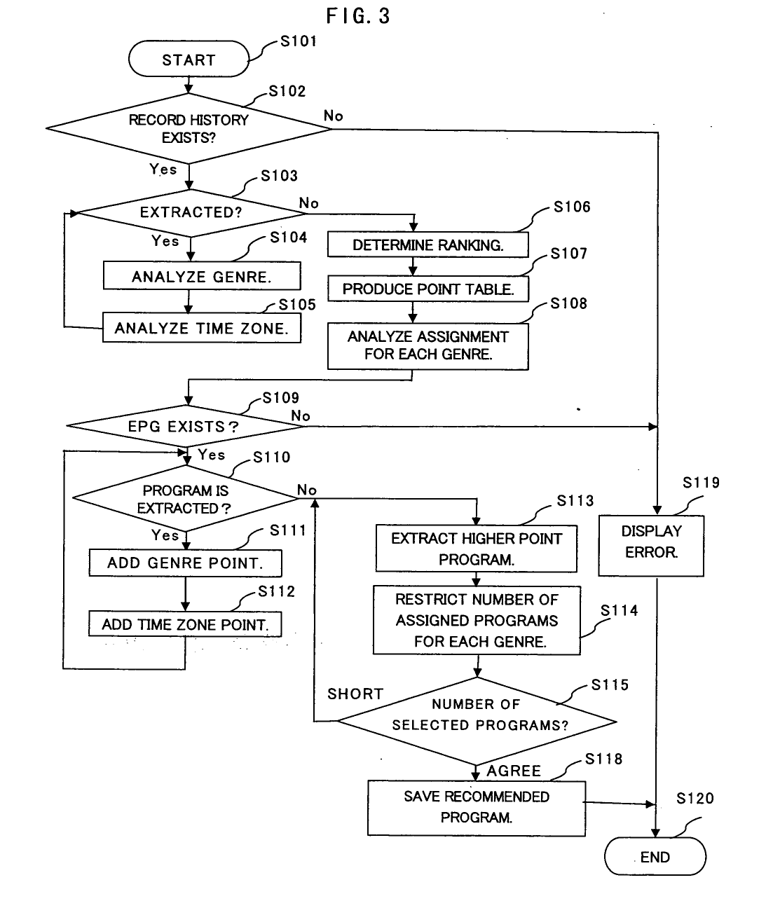

FIG. 3 is a flow chart showing the operation of the recommended program extracting apparatus 1 according to the first embodiment (or a recommended program extracting method according to the first embodiment). In the first embodiment, the CPU 10 performs the process of determining a recommended program in accordance with the software installed in the HDD 12.

Referring to FIG. 3, the extracting of a recommended program is started, for example, after the reception and the analysis process of the EPG data (step S101). In the extracting of a recommended program, first, the record history information which is the data of user's preference is statistically processed. For that purpose, it is checked whether or not the record history information exists in the nonvolatile memory 19 (step S102). If the record history information does not exist, the contents of an error is displayed (step S119) and the determination process of a recommended program finishes (step S120).

If the record history information exists in step S102, information of one program is extracted from the record history information (step S103), an analysis of the genre of the extracted program is performed (step S104), and an analysis of the broadcast start time zone is performed (step S105). In these analyses, the count of the broadcast start time zone is incremented by one when the broadcast start time zone coincides with that of the extracted program and the count of the genre is incremented by one when the genre coincides with that of the extracted program. In this embodiment, a case where the broadcast start time zone includes six kinds of zones of ‘EARLY MORNING’, ‘MORNING’, ‘AFTERNOON’, ‘EVENING’, ‘NIGHT’, and ‘MIDNIGHT’ will be described. Here, ‘EARLY MORNING’ means a time zone from 5:00 to earlier than 8:00 (time is expressed by “hour: minute” and ditto for the following); ‘MORNING’ means a time zone from 8:00 to earlier than 12:00, ‘AFTERNOON’ means a time zone from 12:00 to earlier than 16:00, ‘EVENING’ means a time zone from 16:00 to earlier than 19:00, ‘NIGHT’ means a time zone from 19:00 to earlier than 23:00, and ‘MIDNIGHT’ means from 23:00 to earlier than 5:00. When the broadcast start time of a program is 20:00 and the genre thereof is “MUSIC”, the point (count) of the broadcast start time zone of ‘NIGHT’ is incremented by one and the point of the genre of “MUSIC” is incremented by one. This analysis process is performed for all programs recorded as the record history information (steps S103 to S105). However, it is also possible to set the determination process of a recommended program in such a way that the analysis process is performed within a previously predetermined range (period) of the programs recorded as the record history information.

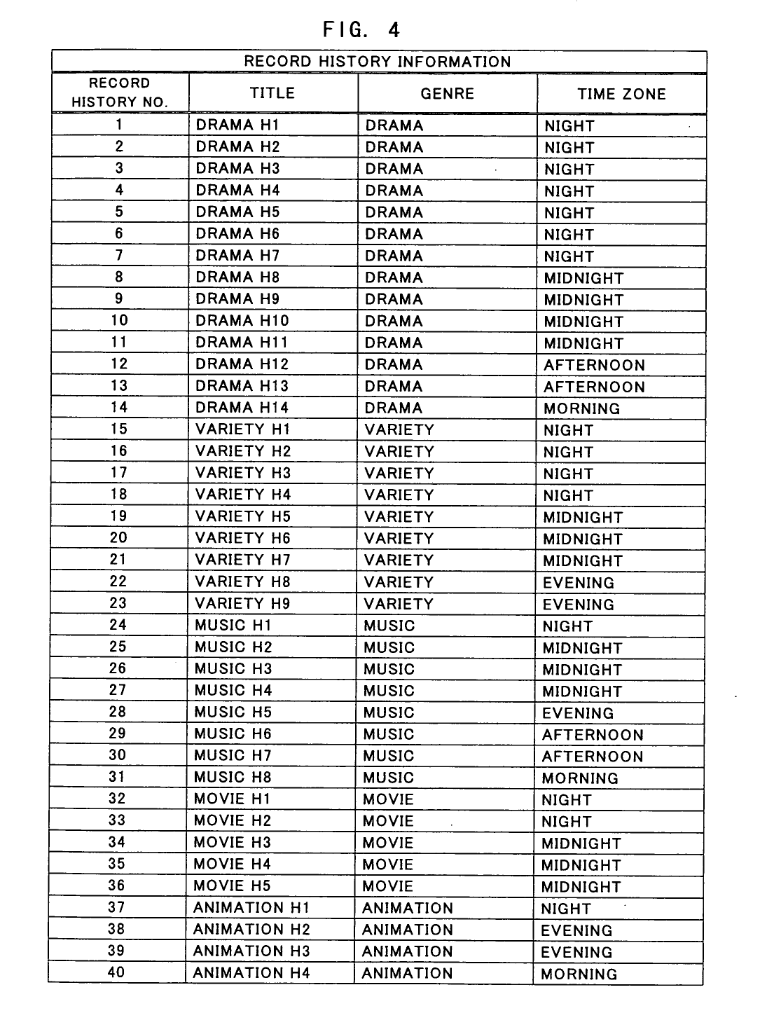

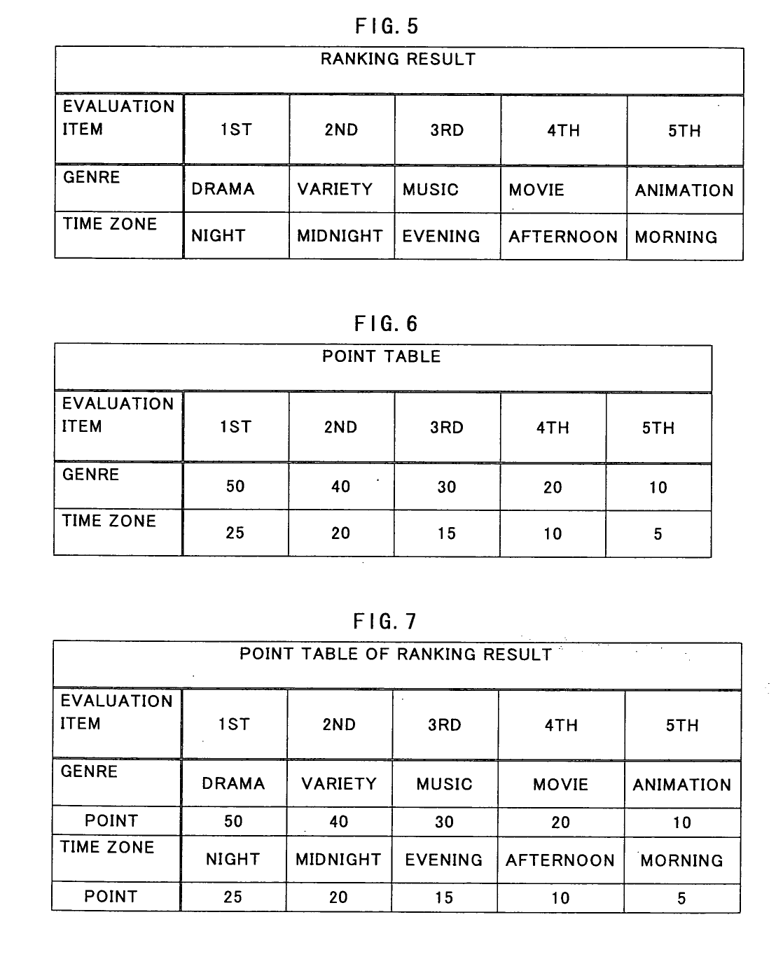

When the statistical process of all of the programs recorded as the record history information is finished, rankings the broadcast start time and the genre are determined (step S106). For example, it is assumed that the programs recorded in the past by the user (record history) are those shown in FIG. 4 (forty programs of record HISTORY NOs. 1 to 40). When this record history is subjected to the statistical process and the ranking determination is performed, the ranking result shown in FIG. 5 is obtained. As shown in FIG. 5, for the genre, among forty programs in FIG. 4, “DRAMA” of fourteen programs is ranked first, “VARIETY” of nine programs is ranked second, “MUSIC” of eight programs is ranked third, “MOVIE” of five programs is ranked fourth, and “ANIMATION” of four programs is ranked fifth. Further, as shown in FIG. 5, for the broadcast start time zone, among forty programs in FIG. 4, ‘NIGHT’ of fifteen programs is ranked first, ‘MIDNIGHT’ of thirteen programs is ranked second, ‘EVENING’ of five programs is ranked third, ‘AFTERNOON’ of four programs is ranked fourth, and ‘MORNING’ of three programs is ranked fifth.

Next, points are assigned to the components of the respective ranked evaluation items (here, a genre and a broadcast start time zone) by the use of, for example, a point table shown in FIG. 6 and previously set. In FIG. 6, for the genre of a previously set evaluation item, 50 points are assigned to the first ranking, 40 points are assigned to the second ranking, 30 points are assigned to the third ranking, 20 points are assigned to the fourth ranking, and 10 points are assigned to the fifth ranking. Moreover, as shown in FIG. 6, for the broadcast start time zone of a previously set evaluation item, 25 points are assigned to the first ranking, 20 points are assigned to the second ranking, 15 points are assigned to the third ranking, 10 points are assigned to the fourth ranking, and 5 points are assigned to the fifth ranking.

From the rankings of components of the evaluation items (the genre and the broadcast start time zone) shown in FIG. 5 and the points assigned to the rankings of components of the evaluation items (the genre and the broadcast start time zone) shown in FIG. 6, a mapping point table shown in FIG. 7 in which points are assigned to the components of the evaluation items can be obtained (step S107). In this embodiment, on the assumption that user's preference is more affected by the genre than by the broadcast start time zone, in the recommendation of the program, assigned points and a difference in the point between the rankings of the genre are made larger than those of the broadcast start time zone. Moreover, although the broadcast start time zone information is used as the broadcast time zone information in this embodiment, other information such as the broadcast end time zone information and the time zone information of a middle point of the broadcast time may be used as the broadcast time zone information.

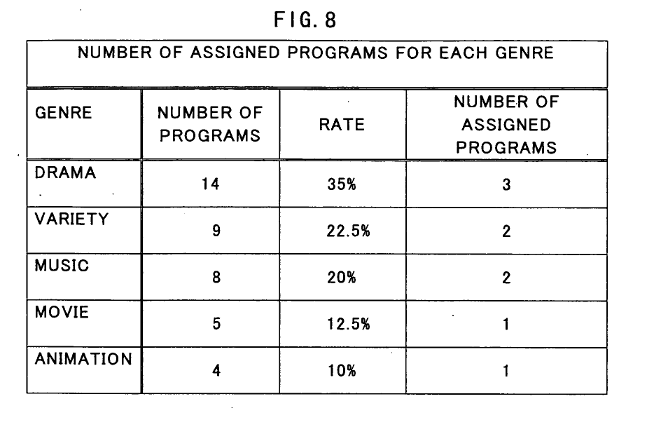

Next, an assignment analysis for each genre of analyzing the distribution which the programs included in the record history information for each genre has (to be more exact, for each component of the genre) is performed (step S108). In the case where the record history information is shown in FIG. 4, fourteen programs are recorded in the genre of “DRAMA”, nine programs are recorded in “VARIETY”, eight programs are recorded in “MUSIC”, five programs are recorded in “MOVIE”, and four programs are recorded in “ANIMATION”. Since the total number of the programs in the record history information is forty programs, as shown in FIG. 8, the rates of each component of the genre are calculated as follows: 35% (=14÷40) for “DRAMA”; 22.5% (=9÷40) for “VARIETY”; 20% (=8÷40) for “MUSIC”; 12.5% (=5÷40) for “MOVIE”; and 10% (=4÷40) for “ANIMATION”. Further, when the number of the programs recommended by the recommended program extracting apparatus 1 is set to ten programs (for example, set by the user), by multiplying the above-mentioned rates by the ten programs of the recommended programs and by discarding a fraction below a decimal point, the number of the programs to be assigned to each component of the genre are determined. In the example shown in FIG. 4, the number of the programs to be assigned to each component of the genre are determined as follows: three programs (=Int(0.35×10)) to “DRAMA”; two programs (=Int(0.225×10)) to “VARIETY”; two programs (=Int(0.2×10)) to “MUSIC”; one program (=Int(0.125×10)) to “MOVIE”; and one program (=Int(0.1×10)) to “ANIMATION”. That is, when it is assumed that the total number of the programs included in the record history information is Na, the number of the programs of each component of the genre are Nm (m=1, 2, . . . ), and the number of the recommended programs is Nr, an integer obtained by discarding a fraction below a decimal point of the number of (Nm/Na)×Nr are used as the number of the programs to be assigned to each component of the genre. Here, when the number of the programs to be assigned to each component of the genre of the recommended programs are determined from the rates of each component of the genre in the record history information, all digits after the decimal point are discarded so as to prevent the total number of the recommended programs from becoming larger than ten programs and nine recommended programs are selected. Since a value set as the number of the recommended programs is ten, one program remains. As for this one remaining program, a method for selecting a program from an element other than the components of the genre of “DRAMA”, “VARIETY”, “MUSIC”, “MOVIE”, and “ANIMATION”, a method for selecting a program from the previously set components of the genre, or a method for not selecting the one remaining program may be selected.

Next, the extracting of the recommended program from the EPG information is started. First, it is checked whether the EPG information of a program scheduled to be broadcast exists in the recommended program extracting apparatus 1 (step S109). Then, if the EPG information does not exist, an error is displayed (step S119) and the determination process of a recommended program is finished (step S120). If the EPG information-exists in step S109, one program is extracted from the EPG information (step S110).

Next, an evaluation of the extracted program is made. The point table shown in FIG. 7 which is found in step S107 is used for making an evaluation of the extracted program. First, an evaluation of genre of the extracted program is made. If a genre coincident with the genre of the extracted program exists in the point table shown in FIG. 7, the point of the coincident genre is added to the point of the extracted program (step S111). Further, an evaluation of the broadcast start time zone of the extracted program is made. If a broadcast start time zone coincident with the broadcast start time zone of the extracted program exists in the point table shown in FIG. 7, the point of the coincident broadcast start time zone is added to the point of the extracted program (step S112). The total sum of these points becomes the total point of the extracted program.

When the processes from step S110 to step S112 in FIG. 3 are performed to all of the programs of the EPG data and these processes are finished, the higher-point program extracting process of extracting programs ranked higher positions in terms of acquired points only by a predetermined number is performed (step S113). Next, for the programs extracted and ranked higher positions in terms of acquired points, in the case where programs of a number more than the number of the assigned programs for each component of the genre exist, the limiting process of the number of the assigned programs for each genre of deleting programs extracted and ranked lower positions in terms of the acquired points of the component of the genre, in which the number of the programs is more than the number of the programs assigned thereto, from candidates for recommended programs thereof is performed (step S114). For example, describing this process by the use of the assignment analysis for each genre (step S108), the process of limiting the number of the recommended programs for each component of the genre is performed in such a way that: the number of the programs for “DRAMA” of the component of the genre is not more than three; the number of the programs for “VARIETY” is not more than two; the number of the programs for “MUSIC” is not more than two; the number of the programs for “MOVIE” is not more than one; and the number of the programs for “ANIMATION” is not more than one.

When the number of the programs selected by the above-mentioned limiting process of the number of the assigned programs for each genre (step S114) is decreased and hence is short of the number of the programs specified as the number of the recommended programs, ten programs for example (step S115), the process is returned again to the higher-point program extracting process (step S113) where programs of the number that is short of the specified number of the recommended programs are added. The above-mentioned process from step S113 to step S115 is repeatedly performed and the extracted programs are stored as recommended programs in the nonvolatile memory 19 (step S118) and the determination process of a recommended program is finished (step S120).

As to the recommended programs extracted by the above-mentioned operation, when the user operates the remote controller 3 to press a “program recommendation” button, a signal is transmitted from the remote controller 3 to the CPU 10 via the remote controller I/F 16. Then, a list of the recommended programs recorded in the nonvolatile memory 19 is read and its information is defined as a graph and is displayed by the display system controller 23 on the monitor 4 via the OSD 18. The user can look at the list of the recommended programs on the monitor 4 to know the recommended programs. Moreover, it is also possible to construct the apparatus in such a way that the user moves a highlight over the list of the recommended programs while looking at the list of the recommended programs on the monitor 4 and presses a determination button to reserve recording or watching the programs. Furthermore, the apparatus may be constructed in such a way that an automatic reservation of recording or watching a predetermined number of the programs ranked higher positions in terms of points, programs acquiring points not less than predetermined points, or programs of a predetermined genre can be made in accordance with the information of the recommended program list.

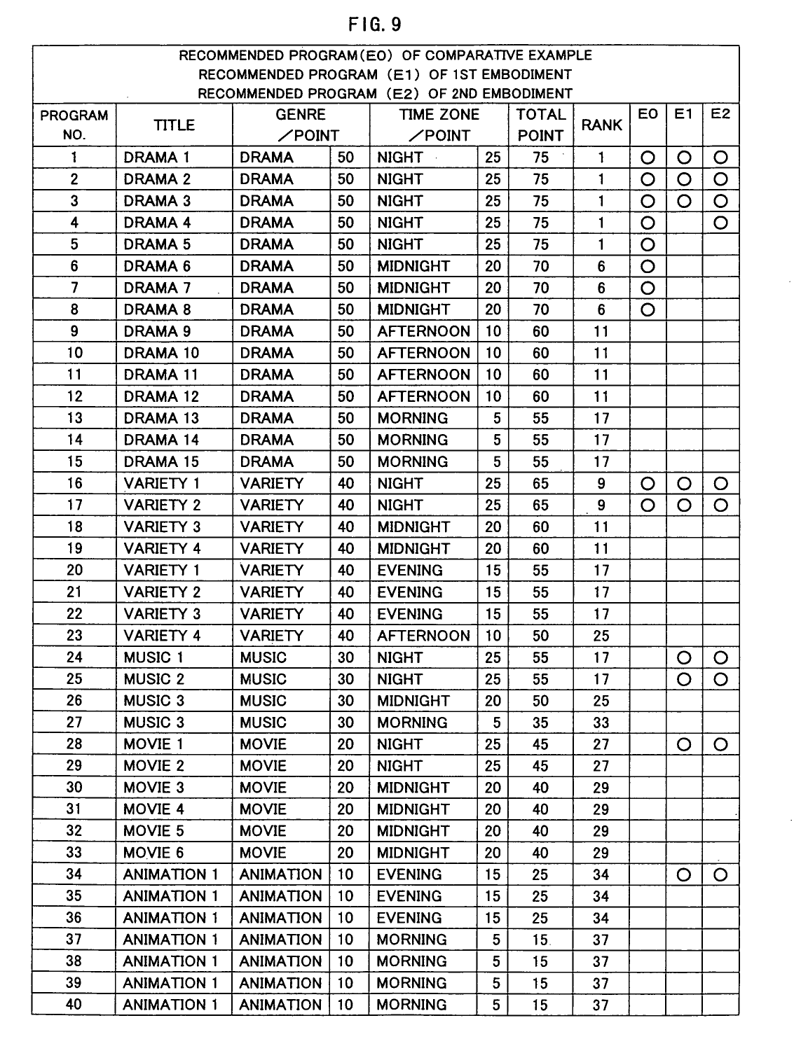

Next, a comparison will be made between a case where programs are selected by the points of the programs and a case where programs are selected by the present process. FIG. 9 shows an example of a program list extracted from the broadcast. Further, FIG. 9 shows the genre points, the time zone points, and the total points, which are determined for each program by the use of FIG. 7 showing the genre points and the time zone points determined by the statistical process in accordance with the record history shown in FIG. 4. When ten programs are determined as the recommended programs from among the programs shown in FIG. 9 only by the ranking of the total points, ten programs ranked the higher positions in terms of the total point are extracted, that is, programs of PROGRAM NOs. 1 to 5 each acquiring a total point of 75, programs of PROGRAM NOs. 6 to 8 each acquiring a total point of 70, programs of PROGRAM NOs. 16 and 17 each acquiring a total point of 65 are extracted as the recommended programs (column E0 in FIG. 9). When this result is checked in terms of the distribution of genre, eight programs are recommended from “DRAMA” and two programs are recommended from “VARIETY”. Therefore, it is found that programs are recommended only from two genres.

Furthermore, in the case of this embodiment where the limiting process of the number of the assigned programs for each genre is performed for the genre, the numbers of the recommended programs for each genre are limited as follows by the assignment analysis for each genre: up to three programs for “DRAMA”; up to two programs for “VARIETY”; up to two programs for “MUSIC”; up to one program for “MOVIE”; and up to one program for “ANIMATION”. Therefore, in the program list shown in FIG. 9, programs of PROGRAM NOs. 1, 2 and 3 are recommended from “DRAMA”, programs of PROGRAM NOs. 16 and 17 are recommended from “VARIETY”, programs of PROGRAM NOs. 24 and 25 are recommended from “MUSIC”, a program of PROGRAM NO. 28 is recommended from “MOVIE”, and a program of PROGRAM NO. 34 is recommended from “ANIMATION”. That is, it is found that programs are recommended from five genres (column E1 in FIG. 9). In this manner, in the first embodiment, programs can be selected in an equitable manner from each component of genre in the record history and in accordance with the assignment (distribution) of each component of genre in the record history by performing the limiting process of the number of the assigned programs for each genre. This can eliminate harmful effect such that programs are recommended intensively in a limited number of genres such as one or two genres just as the case where programs are selected only by the points acquired by the programs.

Moreover, in this embodiment, a case where genre is “DRAMA” and where the number of the programs acquiring points 75 and 70 is eight programs in the program list has been taken as an example of a case where programs are extracted by the point. If the limiting process of the number of the assigned programs for each genre is not performed, when the number of the programs having the same genre and the same time zone (that is, programs of “DRAMA” and ‘NIGHT’) is ten or more, ten programs are selected only from the programs of “DRAMA” by the method for extracting a program by the point and programs of the other genres are never recommended. In contrast, if the limiting process of the number of the assigned programs for each genre is performed, no matter how much the number of the programs of “DRAMA” and ‘NIGHT’ increases, the number of the program of each genre are proportional to the number of the assigned programs for each genre in the record history. Therefore, just as with the above-mentioned case, the programs of PROGRAM NOs. 1, 2 and 3 are recommended from “DRAMA”, the programs of PROGRAM NOs. 16 and 17 are recommended from “VARIETY”, the programs of PROGRAM NOs. 24 and 25 are recommended from “MUSIC”, the program of PROGRAM NO. 28 is recommended from “MOVIE”, and the program of PROGRAM NO. 34 is recommended from “ANIMATION”. Therefore, the recommended programs are not affected by the number and construction of the genres ranked the higher positions in terms of the points.

In the recommended program extracting apparatus of the first embodiment constructed in the above-mentioned manner, the record history information of the user is statistically processed and the more closely the programs match user's preference, the more strongly the programs are recommended. Therefore, the programs closely matching the user's preference are recommended.

Further, since the programs are automatically recommended in accordance with the record history information of the user and the program information, no load is applied to the user.

Furthermore, since the programs are recommended in accordance with the record history information of the user so as to realize the distribution for each genre in accordance with the distribution for each genre of the programs recorded in the past, it is possible to reflect a plurality of preferences of the user to the program recommendation. In particular, when the user records various genres of programs, it is possible to recommend a variety of programs without leaning to the programs of a specific genre. Further, it is possible to prevent the recommended programs from being changed by the number of the programs ranked the higher positions, for example, to prevent a case where when the number of the programs ranked the higher positions increases, the programs ranked the lower positions are not recommended.

Moreover, by using the point method capable of strongly reflecting the user's preference in combination, it is possible to recommend the programs ranked higher positions in terms of the points such as the programs of the genres and the broadcast start time zones ranked the higher positions in terms of the assigned points and to recommend also such programs ranked the lower positions in terms of the points that cannot be easily recommended only by the point method.

Still further, even if no program exists in a genre for which a plurality of programs can be recommended in accordance with the distribution of genre, in this embodiment, a program of the second largest points can be selected because the point method is used in combination.

Still further, although there is a possibility in the point method that a program might be recommended only on the condition of coincidence only in the genre, the recommended program extracting apparatus of the first embodiment is so constructed as to extract the recommended programs from a wide range of genres. Therefore, it is possible to avoid recommending programs on the condition of coincidence only in the genre as much as possible.

Still further, when a recording recommended program extracting apparatus is used by a plurality of users, the recommended program extracting apparatus may be also constructed in such a way that the users (names) who set the recording of the program are stored as the record history information, an analysis of the users is made as an object for a program assignment analysis, that is, as an evaluation item to thereby find the distribution of programs for each user, and the recommended programs are determined in proportion to the distribution of programs. In this case, programs are recommended in accordance with the frequencies of use of the users using the recommended program extracting apparatus, that is, so as to more reflect the preference of the user using the recommended program extracting apparatus frequently.

### Second Embodiment

In the first embodiment, the process for determining the number of the assigned programs for each genre includes the steps of finding the rates of distribution of genre components of the recorded programs in the record history information, and finding the limit value of the number of the programs for each genre in accordance with the result of the rates and the number of the recommended programs. In the second embodiment of the present invention, the process for determining the number of the assigned programs uses the d'Hondt formula as a proportional distribution algorithm.

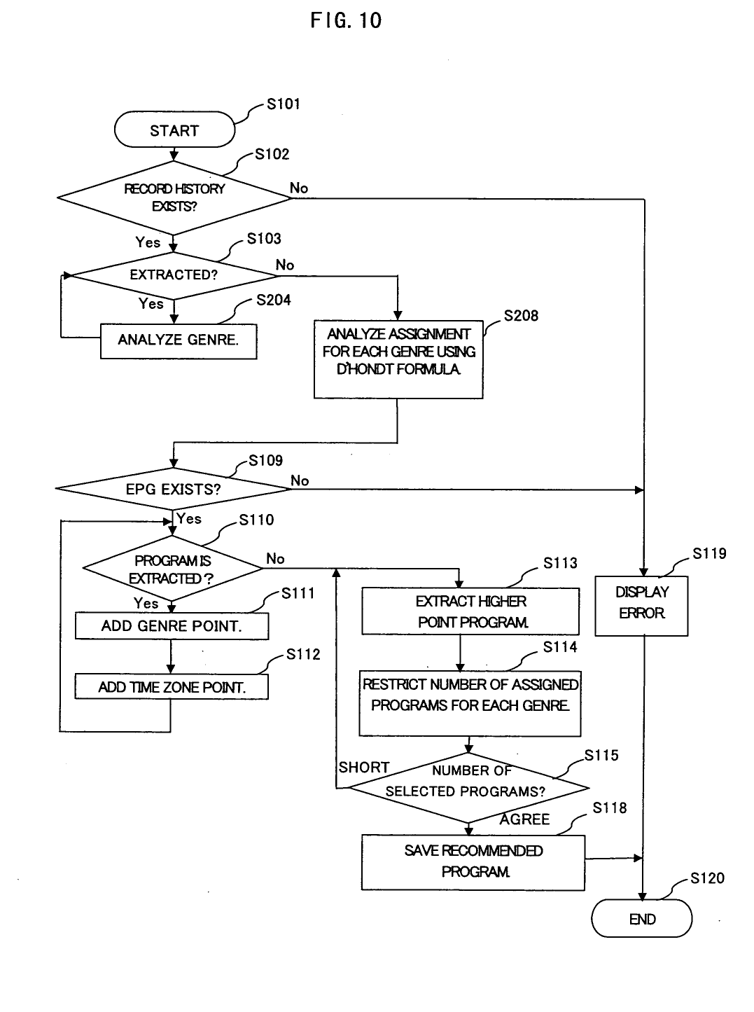

FIG. 10 is a flow chart showing the operation of a recommended program extracting apparatus according to the second embodiment (or a recommended program extracting method according to the second embodiment). In FIG. 10, the same steps as the steps shown in FIG. 3 are denoted by the same reference symbols. As shown in FIG. 10, the operation of the recommended program extracting apparatus according to the second embodiment is different from that of the above-mentioned the first embodiment in that the d'Hondt formula is used in the genre analysis (S104) and the assignment analysis for each genre (S108).

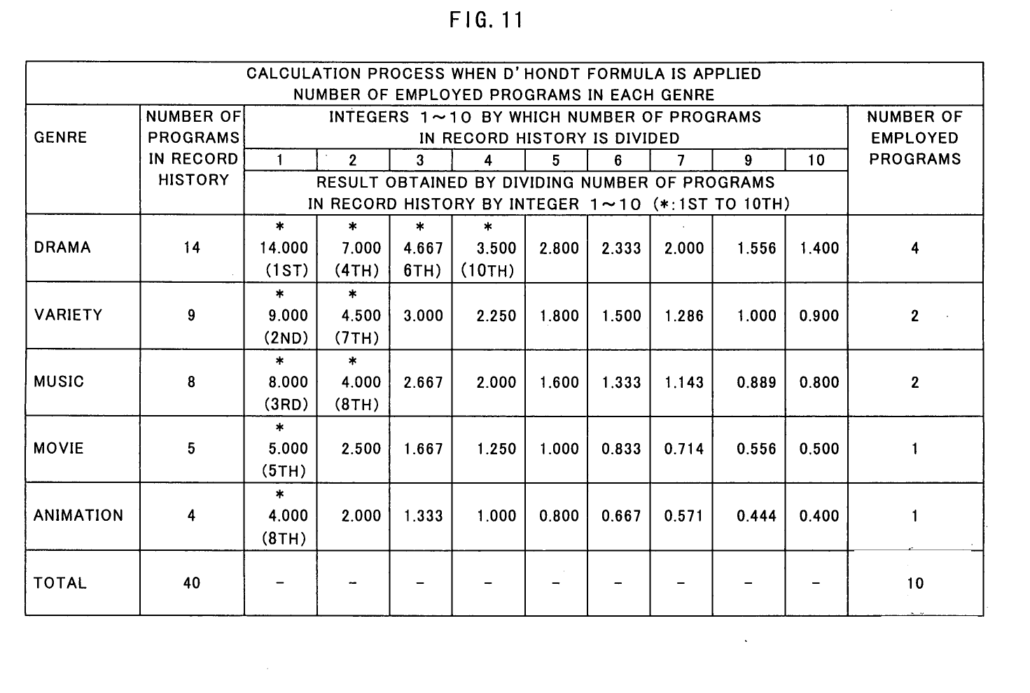

The d'Hondt formula is, for example, one of the methods for computing the number of the seats distributed to respective political parties in an election by a proportional representation system. Further, the d'Hondt formula is a method of dividing the number of votes obtained by the respective political parties by integers in ascending order from one to thereby obtain quotients and of giving the respective political parties the seats in the descending order of the quotients. When the d'Hondt formula is used, the seats can be assigned to the political parties that have obtained more votes and the political parties that have obtained fewer votes in a comparatively equitable manner. In the second embodiment, the d'Hondt formula is used for extracting genres in the program recommendation. In FIG. 11, the number of the programs of each genre in the record history and the quotients obtained when the number of the programs of each genre is divided by integers from 1 to 10. In the case of FIG. 4, fourteen programs of “DRAMA”, nine programs of “VARIETY”, eight programs of “MUSIC”, five programs of “MOVIE”, and four programs of “ANIMATION” are recorded. Then, these numbers of the programs for the respective genres are divided by integers from 1 to 10 to thereby obtain quotients, and then the recommended programs are assigned to the genres in the descending order of the quotients. When the obtained values from the first position to the tenth position, which are denoted by the symbols “*” in FIG. 11, are extracted, programs are extracted at the rates of: four programs of “DRAMA”; two programs of “VARIETY”; two programs of “MUSIC”; one program of “MOVIE”; and one program of “ANIMATION”.

When the second embodiment is compared with the above-mentioned the first embodiment, the second embodiment is characterized in that the number of the programs of “DRAMA” is increased by one to become four programs and in that the total number of the programs is ten which is the same as the number of the set recommended programs, whereas the total number of the programs is nine programs in the first embodiment. The result obtained by applying the number of the assigned programs for each genre, which are determined using the d'Hondt formula, to the list of programs in FIG. 9 is shown in the rightmost column (column E2) in FIG. 9.

In the recording recommended program extracting apparatus of the second embodiment constructed in the above-mentioned manner, it is possible to determine the number of the recommended programs for each genre in accordance with the rate of the number of the programs for each genre in the record history.

Furthermore, it is possible to determine the distribution of the recommended programs using the d'Hondt formula with comparative ease and in proper quantities.

Moreover, it is possible to recommend the programs of genre, the number of which is proportional to the number of the programs of the genre recorded by the user, and hence to recommend the programs in an equitable manner without leaning to a specific genre.

1. A recommended program extracting apparatus comprising:
a recording section which records an inputted broadcast signal in a predetermined recording medium;
a program information acquiring section which acquires program information regarding a broadcast program from the broadcast signal;
a record history storing section which stores record history information which is program information regarding a past broadcast program recorded by the recording section; and
a recommended program extracting section which performs a statistical process of the record history information, the recommended program extracting section extracting a recommended program from programs included in scheduled broadcast program information acquired by the program information acquiring section in accordance with a result of the statistical process;
wherein the recommended program extracting section
finds a number of a program for each component of a predetermined first evaluation item, the program being included in the record history information,
determines a number of an assigned program regarding the recommended program for each component of the first evaluation item in accordance with the number of the program for each component of the first evaluation item, and
extracts the recommended program in such a way that the number of the recommended program is within a range of the number of the assigned program for each component of the first evaluation item.

2. The recommended program extracting apparatus according to claim 1, wherein the first evaluation item includes a genre indicating a classification of a program content.

3. The recommended program extracting apparatus according to claim 1, wherein the extracting of the recommended program by the recommended program extracting section is performed by
finding a number of a program for each component of a second evaluation item, which is included in the record history information,
producing a point table for each component of the second evaluation item, the point table containing a point which is determined in accordance with the number of the program found for each component of the second evaluation item,
assigning the point of each component of the second evaluation item to each program included in the scheduled broadcast program information using the point table, and
extracting a program ranked higher position in terms of a total value of the assigned point in descending order of the total point as the recommended program.

4. The recommended program extracting apparatus according to claim 1, wherein the second evaluation item includes a genre indicating a classification of a program content and a broadcast time zone of a program.

5. The recommended program extracting apparatus according to claim 1, wherein
when a total number of the program included in the record history information is represented as Na, the number of the program for each component of the first evaluation item is represented as Nm, where m is 1, 2, . . . , and the number of the recommended program is represented as Nr,
an integer obtained by discarding a fraction below a decimal point of (Nm/Na)×Nr is used as the number of the recommended program determined by the recommended program extracting section.

6. The recommended program extracting apparatus according to claim 1, wherein the determining of the number of the assigned program by the recommended program extracting section is performed using the d'Hondt formula.

7. A recommended program extracting method comprising the steps of:
recording an inputted broadcast signal in a predetermined recording medium;
acquiring program information regarding a broadcast program from the broadcast signal;
storing record history information which is program information regarding the recorded past broadcast program;
performing a statistical process of the record history information and extracting a recommended program from programs included in scheduled broadcast program information acquired by a program information acquiring section in accordance with a result of the statistical process;
finding a number of a program for each component of a predetermined first evaluation item, the program being included in the record history information; and
determining a number of an assigned program regarding the recommended program for each component of the first evaluation item in accordance with the number of the program for each component of the first evaluation item;
wherein the extracting of the recommended program is performed in such a way that the number of the recommended program is within a range of the number of the assigned program for each component of the first evaluation item.

8. The recommended program extracting method according to claim 7, wherein the first evaluation item includes a genre indicating a classification of a program content.

9. The recommended program extracting method according to claim 7, wherein the extracting of the recommended program by a recommended program extracting section is performed by
finding a number of a program for each component of a second evaluation item, which is included in the record history information,
producing a point table for each component of the second evaluation item, the point table containing a point which is determined in accordance with the number of the program found for each component of the second evaluation item,
assigning the point of each component of the second evaluation item to each program included in the scheduled broadcast program information using the point table, and
extracting a program ranked higher position in terms of a total value of the assigned point in descending order of the total point as the recommended program.

10. The recommended program extracting method according to claim 7, wherein the second evaluation item includes a genre indicating a classification of a program content and a broadcast time zone of a program.

11. The recommended program extracting method according to claim 7, wherein
when a total number of the program included in the record history information is represented as Na, the number of the program for each component of the first evaluation item is represented as Nm, where m is 1, 2, . . . , and the number of the recommended program is represented as Nr,
an integer obtained by discarding a fraction below a decimal point of (Nm/Na)×Nr is used as the number of the recommended program determined by a recommended program extracting section.

12. The recommended program extracting method according to claim 7, wherein the determining of the number of the assigned program by a recommended program extracting section is performed using the d'Hondt formula.
